(19) United States
(12) Patent Application Publication
(10) Pub. No.: US 2026/0280862 A1
(43) Pub. Date: Sep. 17, 2026

(54) DISTRIBUTED QUANTUM EVALUATION NETWORK

(71) Applicant: The United States of America as represented by the Secretary of the Navy, Arlington, VA (US)

(72) Inventors: Antonio Monje, San Marcos, CA (US); Alejandro Monje, San Marcos, CA (US)

(73) Assignee: The United States of America as represented by the Secretary of the Navy, Arlington, VA (US)

(21) Appl. No.: 19/076,178

(22) Filed: Mar. 11, 2025

(51) Int. Cl. H04L 9/08; H04L 9/00; H04L 9/32

(52) U.S. Cl. CPC H04L 9/0852; H04L 9/32; H04L 9/50

(57) ABSTRACT

A distributed quantum evaluation network for decryption. In some embodiments, the steps comprising: receiving an encrypted string; and initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising: emitting an event for external computation by calling a quantum computing software development kit (SDK) application programming interface (API), providing the encrypted string to the quantum computing SDK API; receiving a decrypted output generated by the quantum circuit upon completion of the quantum decryption operations, validating the decrypted output among the plurality of nodes using a distributed consensus protocol, storing a validated decrypted output as a new transaction on the DLN, and updating a distributed ledger state across the plurality of nodes to reflect the storing of the validated decrypted output.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC_Pacific_T2@us.navy.mil, referencing Navy Case No. 212,170.

### FIELD OF USE

The present disclosure pertains generally to a distributed quantum computation network. Specifically, a distributed quantum computation network utilizing quantum processors and parallelized computation.

### BACKGROUND

Current decryption technology relies primarily on classical computing methods to break encrypted data and access secured information. These methods include brute force attacks, which systematically test all possible combinations, and more sophisticated approaches like rainbow tables and dictionary attacks that are specifically designed to crack password hashes. Modern decryption techniques also focus on breaking cryptographic keys, particularly in asymmetric encryption systems where public and private key pairs are used to secure data transmission.

The security of many current systems depends on the computational difficulty of breaking cryptographic hashes and encrypted passwords. Common approaches include using specialized hardware like GPUs and distributed computing networks to parallelize the decryption process. Password recovery methods often exploit patterns in human password creation, while key decryption typically involves mathematical algorithms designed to factor large numbers or solve complex mathematical problems.

Quantum computing represents a revolutionary approach to computation that uses quantum mechanical principles like superposition and entanglement. Two significant quantum algorithms have particular relevance to cryptography: Shor's algorithm, which can efficiently factor large numbers and thereby break many current encryption systems, and Grover's algorithm, which provides a quadratic speedup for searching unstructured databases. These algorithms demonstrate quantum computing's potential to fundamentally change the landscape of cryptographic security.

The development of quantum computing technology has led to the creation of specialized development platforms and simulators. IBM's Qiskit and Google's Cirq are prominent examples of frameworks that allow developers to create and test quantum algorithms. These platforms provide access to both quantum simulators that run on classical computers and actual quantum hardware through cloud services. Current quantum computers are limited in their capabilities, with challenges in maintaining qubit stability and managing quantum error correction, but they show promising progress in processing power and reliability.

Distributed ledger networks, particularly blockchain technology, provide decentralized and secure methods for recording and verifying transactions. These methods and systems offer benefits including transparency, immutability, and resistance to tampering, but face challenges with scalability and potential vulnerability to quantum computing attacks. Modern distributed ledger systems often incorporate external computing resources through application program interfaces (APIs), allowing them to interact with both classical and quantum computing systems for enhanced functionality and security analysis.

In the field of decryption and cryptanalysis, practitioners face substantial technical and economic barriers due to the intensive computational resources required. Contemporary decryption methods often demand significant processing time and hardware infrastructure, resulting in costly operations that may be impractical for many applications. The need exists for improved systems and methods that can perform decryption and cryptanalytic operations more efficiently, with reduced computational overhead and accelerated processing times. Current approaches frequently require extensive parallel processing capabilities, specialized hardware configurations, or prohibitively expensive computing resources, highlighting the technical problem of achieving rapid and resource-efficient decryption operations in practical implementations.

### SUMMARY

According to illustrative embodiments, a distributed quantum decryption method, the steps comprising: receiving an encrypted string; and initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising: emitting an event for external computation by calling a quantum computing software development kit (SDK) application programming interface (API), providing the encrypted string to the quantum computing SDK API, wherein the quantum computing SDK API initiates execution of a quantum circuit configured to perform quantum decryption operation; receiving a decrypted output generated by the quantum circuit upon completion of the quantum decryption operations, validating the decrypted output among the plurality of nodes using a distributed consensus protocol, storing a validated decrypted output as a new transaction on the DLN, and updating a distributed ledger state across the plurality of nodes to reflect the storing of the validated decrypted output.

In some embodiments, a computer-implemented distributed quantum decryption method, the steps comprising: receiving an encrypted string; and initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising: emitting an event for external computation by calling a quantum computing software development kit (SDK) application programming interface (API), providing the encrypted string to the quantum computing SDK API, wherein the quantum computing SDK API initiates execution of a quantum circuit configured to perform quantum decryption operation; receiving a decrypted output generated by the quantum circuit upon completion of the quantum decryption operations, validating the decrypted output among the plurality of nodes using a distributed consensus protocol, storing a validated decrypted output as a new transaction on the DLN, and updating a distributed ledger state across the plurality of nodes to reflect the storing of the validated decrypted output.

In some embodiments, a non-transitory computer-readable storage medium comprising computer readable instructions for a distributed quantum decryption method, the instructions performing operations comprising receiving an encrypted string; and initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising: emitting an event for external computation by calling a quantum computing software development kit (SDK) application programming interface (API), providing the encrypted string to the quantum computing SDK API, wherein the quantum computing SDK API initiates execution of a quantum circuit configured to perform quantum decryption operation; receiving a decrypted output generated by the quantum circuit upon completion of the quantum decryption operations, validating the decrypted output among the plurality of nodes using a distributed consensus protocol, storing a validated decrypted output as a new transaction on the DLN, and updating a distributed ledger state across the plurality of nodes to reflect the storing of the validated decrypted output.

It is an object to provide a Distributed Quantum Evaluation Network that offers numerous benefits, including massive parallel processing capability, modular and adaptable architecture, and enhanced computational efficiency. These benefits represent significant technical advantages in the field of cryptanalysis and computational processing. The system's ability to leverage multiple blockchain nodes for parallel quantum computing operations, combined with the modular architecture of Hyperledger Fabric or similar blockchains, enables unprecedented scaling and flexibility in cryptanalytic operations. This architecture facilitates exponential speed improvements over traditional CPU/GPU-based systems while maintaining a robust consensus mechanism for result verification.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 shows an illustration of an encrypted string being received by a computing device having a backend configured to deliver chaincode to a distributed ledger network (DLN) comprising a plurality of nodes, wherein each node interfaces with a quantum computer.

FIG. 2 shows a block diagram illustration of a distributed quantum decryption method.

FIG. 3 shows a block-diagram illustration of a computing device comprising memory, processor(s), front end comprising a user interface, and a backend comprising a network(s) interface configured to interface with a distributed ledger network configured to interface to a quantum software development kit (SDK) application program interface (API).

FIG. 4 shows an illustration of a DLN comprising a plurality of nodes each associated with a ledger.

FIG. 5 shows an illustration of one of the plurality of nodes being configured to interface with a quantum computer.

### DETAILED DESCRIPTION OF EMBODIMENTS

The disclosed system and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other system and method described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

The present disclosure relates to systems and methods for cryptographic analysis through a Distributed Quantum Evaluation Network that combines blockchain technology with quantum computing capabilities. This network leverages distributed blockchain architecture and integrates with quantum computing resources through quantum programming Software Development Kits (SDKs) to create a highly efficient platform for parallel cryptographic operations. The system enables simultaneous execution of quantum algorithms, such as Grover's algorithm, across multiple blockchain nodes, with results validated through blockchain consensus mechanisms and permanently recorded in an immutable ledger.

The Distributed Quantum Evaluation Network utilizes distributed ledger technology to coordinate multiple quantum computing operations, enabling parallel processing of cryptographic challenges including hash matching, password analysis, and key evaluation. Each node in the network independently executes quantum algorithms while maintaining synchronization through blockchain consensus protocols, creating a robust and scalable system for cryptographic analysis.

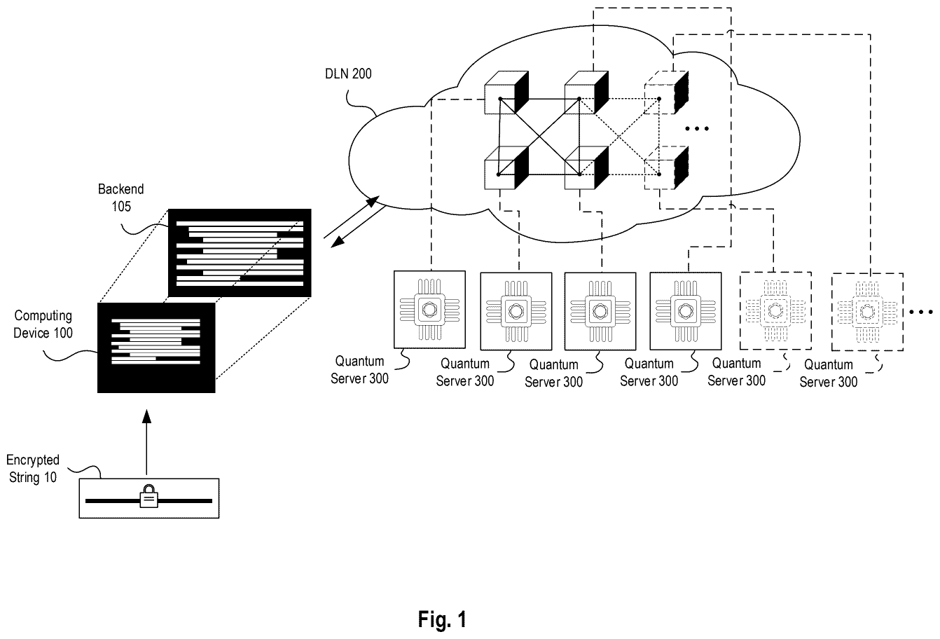

FIG. 1 shows an illustration of an Distributed Quantum Evaluation Network comprising an encrypted string 10 being received by a computing device 100 comprising a backend 105 configured to deliver chaincode to a distributed ledger network 200 comprising a plurality of nodes 201, wherein each node 201 interfaces with one of a plurality of quantum computer 300. FIG. 1 illustrates that the quantity of nodes 201 and quantum computers 300 is scalable up to the number of nodes supported by the distributed ledger network 200. The Distributed Quantum Evaluation Network is particularly well-suited for deployment in high-security environments such as financial institutions, government agencies, and cybersecurity firms where cryptographic analysis and security validation are critical operations. In these settings, the network can be utilized for security auditing, penetration testing, and validation of encryption implementations. The system's ability to maintain detailed, immutable records of all operations makes it especially valuable for compliance-focused organizations that require comprehensive audit trails of security testing activities.

The Distributed Quantum Evaluation Network also finds significant application in research and development environments, including academic institutions and corporate research facilities. In these settings, the system can be used to conduct parallel quantum computing experiments, evaluate new cryptographic algorithms, and study quantum-resistant encryption methods. The modular nature of the network allows for easy modification of quantum algorithms and testing parameters, making it an ideal platform for experimental research in quantum computing and cryptography.

The encrypted string 10 may be received by the computing device 100 by a user entering the string 10 into a graphical interface (GUI). Encrypted strings 10 (e.g. Cryptographic hashes) represent fundamental constructs in modern cryptography, with encrypted strings 10 utilizing symmetric (e.g., AES-256 in CBC, GCM modes) or asymmetric (e.g., RSA, ECC) algorithms to transform plaintext into ciphertext through complex mathematical operations, while maintaining bijective mappings for authorized decryption. Cryptographic hash functions (e.g., SHA-256, SHA-3, BLAKE2) implement deterministic one-way compression functions that map arbitrary-length input to fixed-length output with essential properties including pre-image resistance, second pre-image resistance, and collision resistance, achieved through Merkle-Damgård construction or sponge functions. Modern applications often employ hybrid cryptosystems combining asymmetric key exchange (e.g., Diffie-Hellman) with symmetric encryption for optimal performance, while hash functions serve crucial roles in digital signatures, commitment schemes, and proof-of-work systems, with security proofs often based on computational hardness assumptions and reduction to well-studied mathematical problems.

A computing device 100 typically includes a variety of non-transitory computer readable media. By way of example, and not limitation, computer readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100. Computer storage media does not, however, include propagated signals. Rather, computer storage media excludes propagated signals. Any such computer storage media may be part of computing device 100.

The computing device 100 comprises a backend 105 configured to deliver chaincode to a node of the DLN (e.g. blockchain). A backend 105 system represents the server-side infrastructure of a computing architecture that processes, stores, and manages data while remaining invisible to end users, typically consisting of servers, databases, and application programming interfaces (APIs). In blockchain implementations, APIs serve as intermediaries that facilitate communication between external applications and the blockchain network, enabling secure data transmission and execution of smart contracts (also known as chaincode in some blockchain platforms). These APIs can deliver chaincode to the blockchain network through specific endpoints that handle deployment requests, where the chaincode is packaged, validated, and distributed to the network's peers according to the blockchain platform's protocols, such as those used in Hyperledger Fabric where chaincode defines the business logic and rules for modifying the blockchain's state. The backend system manages this process by coordinating the API calls, handling authentication, and ensuring proper deployment of the chaincode across the distributed network while maintaining security and consistency.

The distributed ledger network 200 is distributed, immutable ledger architecture implementing a decentralized consensus mechanism through cryptographic primitives and game-theoretic incentive structures. The fundamental data structure consists of cryptographically linked blocks containing ordered transactions, a timestamp, nonce, and the previous block's hash, forming a tamper-evident chain of records. Contemporary implementations typically employ either Proof-of-Work (PoW) or Proof-of-Stake (PoS) consensus protocols, with the former utilizing computational puzzles based on hash functions to achieve Byzantine fault tolerance, while the latter leverages economic stakes to ensure network security.

In a distributed ledger network 200, a plurality of nodes 201 are individual computing devices or servers that participate in the network by maintaining a copy of the distributed ledger network 200 and, depending on their role, validating and processing transactions. The quantity of nodes shown in FIG. 1 is merely illustrative and in no way limiting on this disclosure. The plurality of nodes 201 may comprise as many nodes as the blockchain can support. Furthermore, the plurality of nodes 201 is readily expandable and scalable to accommodate the methods and systems described herein. These nodes work together through consensus mechanisms, where participating nodes verify transactions, create new blocks containing validated transactions, and agree on the state of the network, ensuring the integrity and immutability of the blockchain. In systems like Hyperledger Fabric, different types of nodes serve specific functions-such as endorsing nodes that execute and validate chaincode, ordering nodes that create and distribute new blocks, and peer nodes that maintain ledger copies—all working in concert to maintain the network's security and functionality.

A quantum computer 300 leverages the principles of quantum mechanics, specifically superposition and entanglement, to perform computations using quantum bits (qubits) that can exist in multiple states simultaneously, unlike classical bits. The essential components of a quantum computer may include the physical qubits (implemented through various technologies such as superconducting circuits, trapped ions, or photonic systems), quantum gates (unitary transformations that manipulate qubit states), error correction mechanisms (to mitigate decoherence and quantum noise), control systems (precise microwave or laser pulses for qubit manipulation), and a dilution refrigerator (for maintaining near-absolute zero temperatures in superconducting implementations). The quantum circuit model, which is the predominant paradigm, employs these components to execute quantum algorithms like Shor's factoring algorithm, Grover's search algorithm, and quantum simulation protocols, offering potential exponential speedup for specific computational problems that are intractable on classical computers. However, current quantum computers face challenges in scaling up while maintaining coherence times and gate fidelities, making error correction and fault tolerance critical areas of ongoing research in the field.

A quantum computer 300 may comprise a quantum software development frameworks (SDKs), such as IBM Qiskit or Google Cirq, which represent high-level abstraction layers for quantum programming that implement comprehensive toolkits for quantum circuit design, optimization, and execution. These frameworks provide sophisticated tensor network simulators, quantum circuit compilation pipelines, and hardware-specific optimizers that translate abstract quantum algorithms into physical quantum operations while accounting for hardware constraints and error rates. They may implement advanced features such as quantum error mitigation techniques, pulse-level control sequences, and dynamic circuit optimization strategies while offering interfaces to both quantum hardware and classical simulators. The frameworks may also incorporate noise models, topology-aware mapping algorithms, and quantum error correction protocols, while providing tools for quantum state tomography, randomized benchmarking, and cross-entropy benchmarking. Quantum SDKs integrate with cloud-based quantum computing platforms, providing APIs for algorithms integrating classical and quantum computations.

Quantum simulators are specialized devices that mimic the behavior of quantum systems by using controllable quantum elements, such as trapped ions, superconducting circuits, or ultracold atoms, to replicate and study complex quantum phenomena that would be practically impossible to simulate using classical computers. These devices serve as an intermediate step between classical computers and full-scale quantum computers.

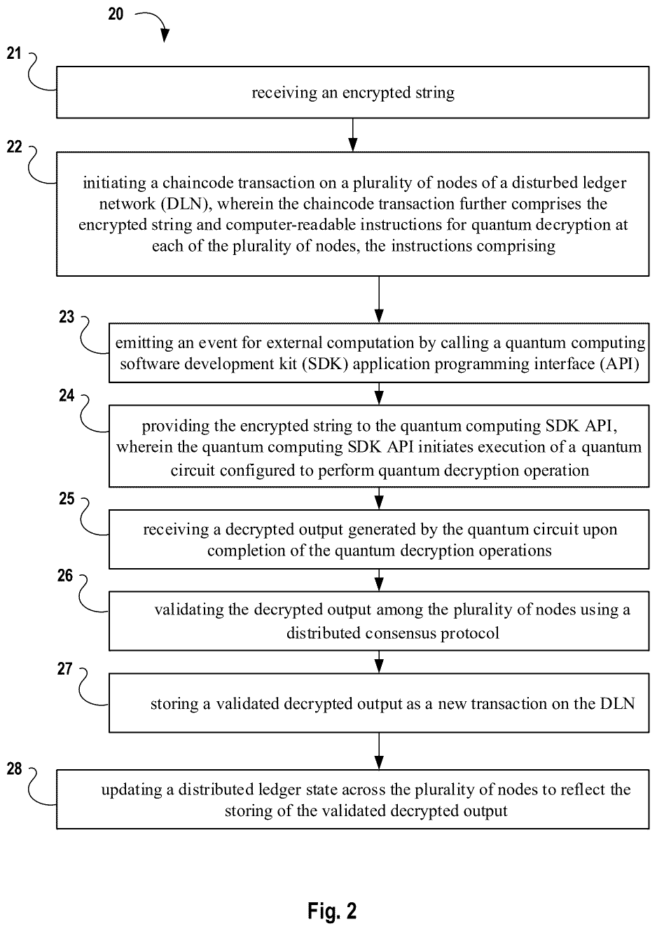

FIG. 2 shows a block diagram illustration of a distributed quantum decryption method and computer-implemented method 20, the steps comprising: receiving an encrypted string 21; and initiating a chaincode transaction on a plurality of nodes of a disturbed ledger network (DLN), wherein the chaincode transaction further comprises the encrypted string and computer-readable instructions for quantum decryption at each of the plurality of nodes 22, the instructions comprising: emitting an event for external computation by calling a quantum computing software development kit (SDK) application programming interface (API) 23, providing the encrypted string to the quantum computing SDK API, wherein the quantum computing SDK API initiates execution of a quantum circuit configured to perform quantum decryption operation 24; receiving a decrypted output generated by the quantum circuit upon completion of the quantum decryption operations 25, validating the decrypted output among the plurality of nodes using a distributed consensus protocol 26, storing a validated decrypted output as a new transaction on the DLN 27, and updating a distributed ledger state across the plurality of nodes to reflect the storing of the validated decrypted output 28.

The step of receiving an encrypted string 21 may further comprise, wherein the encrypted string 10 is received via a graphical user interface, entered by, for example, a user. In some embodiments, the encrypted string may be received or delivered from a server or application seeking to utilized the distributed quantum decryption method.

The step of initiating a chaincode transaction on a plurality of nodes of a disturbed ledger network (DLN), wherein the chaincode transaction further comprises the encrypted string 10 and computer-readable instructions for quantum decryption at each of the plurality of nodes 22, comprises a the computing device 100 transmitting a chaincode transaction to a plurality of nodes in a DLN, such a blockchain network. The chaincode transaction is deployed to the plurality of nodes to execute in parallel to ensure ensures deterministic execution. In some embodiments, the DLN further comprises and immutable ledger. In some embodiments, the DLN is the blockchain platform Hyperledger Fabric.

While one embodiment of the distributed ledger network comprises Hyperledger Fabric, similar blockchains with the requisite functionality may also be utilized. For example. Hyperledger Sawtooth may also be employed. Core features of an appropriate blockchain can include a modular architecture, a permissioned or permissionless framework, smart contract execution capabilities, an immutable ledger, and an ordering service. However, certain blockchains possessing characteristics incompatible with the intended functionality may be less desirable. For instance, blockchains demanding substantial computational resources or lacking smart contract capabilities may prove unsuitable. Accordingly, blockchains lacking modularity, scalability, or off-chain API integration may also be considered less appropriate. Similar blockchains may be implemented, with Hyperledger Fabric serving as one illustrative embodiment.

Significant advantages are gained from the use of quantum hardware and by parallel computation with the plurality of nodes. Shor's integer factorization algorithm enables the cracking of, for example, an RSA encryption key based on the prime numbers at an exponentially faster rate that classical computers. By parallelizing these computations, the method provides a robust technique of validating the computations. The likelihood that the plurality of nodes reaches a consensus on the correct decryption rises by adding additional nodes. As another example, Grover's unstructured search algorithm is similarly empowered to search by quantum computing at an exponentially faster rate than classical computers. Specifically, Grover's algorithm can speed up brute force of hash functions from O (2ⁿ) to O (2^{n/2}). Accordingly, this method may overcome current speed challenges with decryption due to its quantum hardware. Issues arising from quantum decoherence, hardware imperfections and noise, may then be alleviated due the DLN validation process.

The step of emitting an event for external computation by calling a quantum computing software development kit (SDK) application programming interface (API) 23. Emitting an event comprises the chaincode signaling that a specific action or state change has occurred. As an illustrative example, it may be thought of as the chaincode broadcasting a notification to the outside world (or to other nodes of the DLN).

The step of providing the encrypted string 10 to the SDK API, wherein the quantum computing SDK API initiates execution of a quantum circuit configured to perform quantum decryption operation 24. In some embodiments, the quantum circuit is designed to implement Grover's Algorithm for an unstructured search. In some embodiments, the quantum circuit is designed to implement Shor's Algorithm for integer factoring decryption.

The step of initiating receiving a decrypted output generated by the quantum circuit upon completion of the quantum decryption operations 25 comprises each of the plurality of nodes 22 receiving a decrypted output from each of their API calls to the quantum computing SDK API. At this step, quantum computation has been done in parallel, meaning that the results of each computation may not be identical. Different quantum hardware platforms and node configurations can significantly impact the execution time and outcome of quantum computations. Due to variations in qubit coherence, gate fidelity, and connectivity across different quantum resources, solving a particular hash problem may proceed at varying speeds, or even result in a determination that no solution exists within a reasonable timeframe. Furthermore, inherent quantum phenomena such as decoherence and quantum noise introduce a degree of variability in the results. Finally, the possibility of hash collisions means that multiple inputs could potentially produce the same output. The consensus mechanism then serves to reconcile these diverse results and select the most reliable outcome.

The step of validating the decrypted output among the plurality of nodes using a distributed consensus protocol 26 may utilize a distributed consensus protocol of the DLN. For example, the distributed consensus protocol achieves consensus through a mechanism selected from the group consisting of voting, proof-of-work, and proof-of-stake.

The step of storing a validated decrypted output as a new transaction on the DLN 27 comprises a transaction, representing a validated decrypted output, being stored on a blockchain by being cryptographically hashed and included in a block along with other transactions. This block is then added to the existing chain, with its hash linked to the previous block, ensuring immutability and a verifiable history of the decrypted output.

The step of updating a distributed ledger state across the plurality of nodes to reflect the storing of the validated decrypted output 28 comprises a creating a cryptographic commitment to the new world state. The new world state is then included in the block header along with other relevant metadata. By including this commitment, each node can independently verify the integrity of its local world state against the block header, ensuring consistency and preventing tampering. Additionally, the updated world state is available to the user for quick-lookup on decrypted hashed.

In one embodiment, the distributed quantum decryption method may further comprise the step of presenting the decrypted output to a graphical user interface or an application programming interface. Accordingly, the decrypted output is available upon request to the user and/or is able to be queried in the distributed ledger state. The distributed ledger state may also be referred to as the world state.

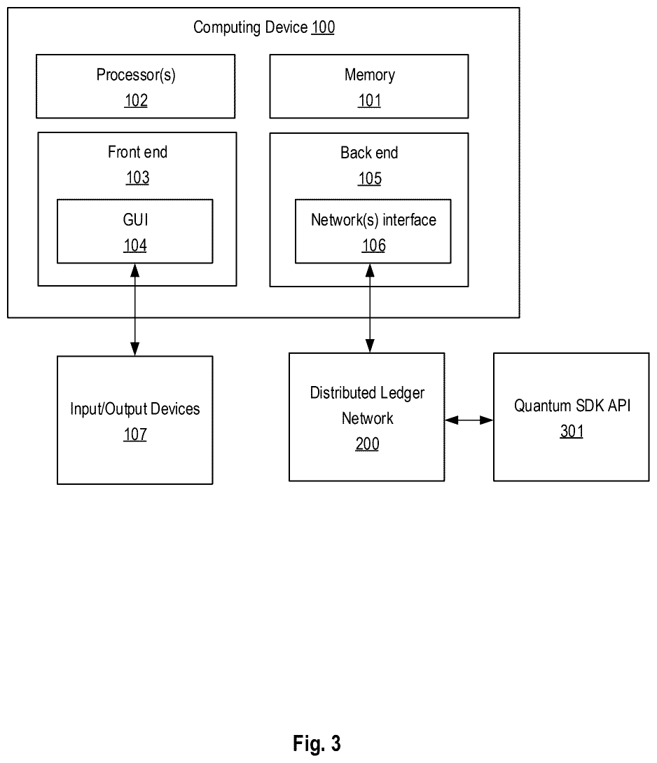

FIG. 3 shows a block-diagram illustration of a computing device 100 comprising memory 101, processor(s) 102, front end 103, comprising a user interface 104, and a backend 105 comprising a network(s) interface configured to interface with a distributed ledger network 200 configured to interface to a quantum software development kit application program interface 301. The computing device 100 provides an access and control point for a user providing an encrypted string 10 for decryption or searching. In some embodiments, the computing device is wire/wireless connected to input/output devices 107 and a DLN 200. The DLN 200 may be wired/wirelessly connected to a Quantum SDK API module. Furthermore, the computing device 100 is electrically connected to the memory 101, processor(s) 102, front end 103 comprising a user interface 104, and a backend 105.

Memory 101 includes computer storage media in the form of volatile and/or nonvolatile memory. The memory may be removable, non-removable, or a combination thereof. Examples of hardware devices include solid-state memory, hard drives, optical-disc drives, etc. Processors 102 read data from various entities such as memory 102 or I/O components 107. Memory 102 stores, among other data, one or more applications. The applications, when executed by the one or more processors, operate to perform functionality on the computing device 100. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application.

The front end 103 of a computing device 100 comprises the user interface 104 components, including the display screen, keyboard, mouse, and other input/output devices that enable direct interaction between the user and the computing system. The front end 103 is a part of the same computing device 100 system as the backed 105. The backend 105 comprises a network(s) interface 106 configured to interface with a distributed ledger network 200 configured to interface to a quantum software development kit application program interface 301. In some embodiments, user account is required to interface with a SDK API, which allows the host to track and allocate resources.

The quantum Software Development Kits (SDKs) and Application Programming Interfaces (APIs) 301 represent distinct but interconnected abstractions in software architecture. An SDK encompasses a comprehensive collection of development tools, libraries, documentation, code samples, and runtime environments that facilitate the development of applications for specific platforms or frameworks. APIs, which are often components of SDKs, define formal interface specifications that enable programmatic interactions between software components through well-defined protocols, data structures, and function calls.

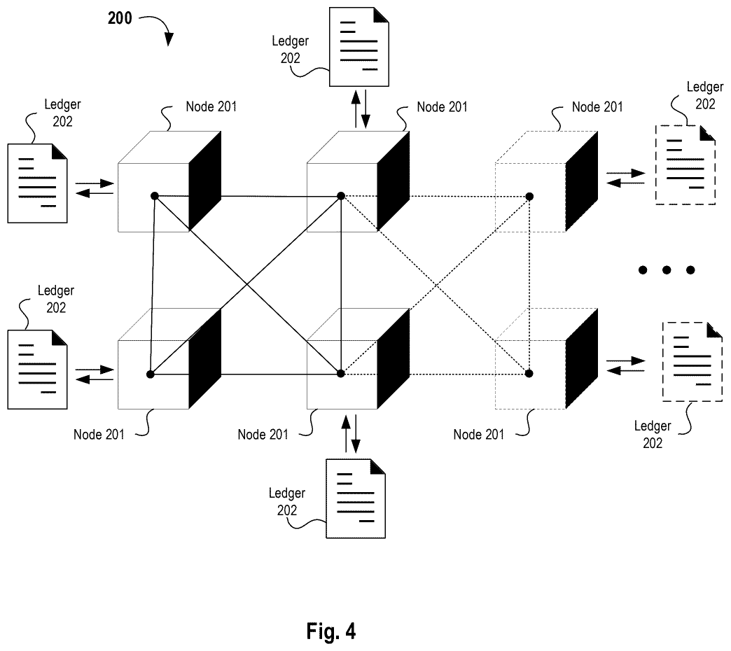

FIG. 4 shows an illustration of a DLN 200 comprising a plurality of nodes 201 each associated with a ledger 202. The number of nodes 201 and corresponding ledgers 202 shown in FIG. 4 are merely illustrative and are not so limited. The plurality of nodes 201 may comprise as many as the blockchain can support and is readily scalable. Nodes 201 in a DLN network establish peer-to-peer connections through a combination of wired (e.g., Ethernet, fiber optic cables) and wireless (e.g., Wi-Fi, cellular networks) communication protocols, utilizing TCP/IP networking standards to discover, authenticate, and maintain connections with other nodes across geographically distributed locations, thereby forming a decentralized mesh topology that ensures redundancy and fault tolerance in the network. A ledger 202 represents a distributed, decentralized database architecture wherein each block contains timestamped transaction data that, once validated and added to the chain, cannot be altered due to cryptographic hashing mechanisms that link each block to its predecessor, thereby ensuring immutability of the recorded information. In this ledger 202, nodes (participating computers in the network) propose new transactions by broadcasting them to the network, whereupon multiple nodes validate these transactions through consensus mechanisms (such as Proof of Work or Proof of Stake), and upon reaching consensus, the validated transactions are compiled into a new block that is cryptographically sealed with a hash value incorporating the previous block's hash, thereby creating an unbreakable chain of chronological records that can be independently verified by any node in the network, but cannot be retroactively modified without detection.

In one embodiment, a distributed quantum decryption method, system, or computer-implemented comprises a DLN 200 being the blockchain platform Hyperledger Fabric. Hyperledger Fabric may be interacted with via the following example, where communicating with the Hyperledger Fabric via chaincode is described. In a first step, the chaincode defines a function (e.g., ProcessHash) to receive the input hash. Example function signature in Go:
goCopyEditfunc (s *SmartContract) ProcessHash(ctx contractapi.TransactionContextInterface, inputHash string) error {// Perform operations with inputHash}

In a second step, the hash may be send to an external API. Because chaincode execution is deterministic, all peers receive the same response from the external API. In some embodiments, it is desirable to handle API calls outside of the chaincode for consistent behavior. An example function is as follows:
goCopyEditresp, err:=http.Post(“https://api.example.com/crack”, “application/json”, bytes.NewBuffer([]byte(inputHash))) if err!=nil {return fmt.Errorf(“Failed to call external API: % v”, err)}
defer resp.Body.Close( )
body, _:=ioutil.ReadAll(resp.Body) crackedResult:=string(body)

In a third step, once chaincode receives the response from the external API, it can store the hash and result in the leger. An example function is as follows:
goCopyEditerr=ctx.GetStub( ).PutState(inputHash, []byte(crackedResult)) if err!=nil {return fmt.Errorf(“Failed to store result: % v”, err)}

In a fourth step, a PutState operation may update the world state with the hash and result mapping, which enables quick lookup functionality.

Furthermore, some embodiments comprising Hyperledger Fabric or similar blockchains may further comprise a consensus process. The Hyperledger Fabric consensus process, as an example comprises an endorsement phase, ordering phase, validation phase, and commit phase. Similar blockchains may have an analogous or functionally equivalent consensus process. In the endorsement phase, transactions are proposed by clients (via SDK) to the endorsing peers. Endorsing peers execute the chaincode (i.e. smart contract) to simulate the transaction and generate a signed response (i.e. endorsement). The endorsement policy specifies which and how many peers must endorse a transaction. Transactions with sufficient endorsements may be submitted to the ordering service. The ordering service may batch transactions into blocks and sequences them. Hyperledger Fabric supports various ordering mechanisms, including Solo, Karka/Zookeeper, and Raft. Solo provides a single-node setup, often utilized for testing. Kafka/Zookeeper provides a crash-fault tolerant ordering mechanism. And finally, Raft provides a leader-based consensus protocol widely used in production. In the validation phase, peers receive the ordered block from the ordering service. Thereafter, an Endorsement Policy Check may ensure that the transaction was endorsed by the required peers. In some embodiments, a MVCC (Multi-Version Concurrency Control) may be utilized to prevent double-spending or conflicting updates by ensuring that the world state has not changed since the transaction was proposed. If validation passes, the transaction is committed to the ledger (blockchain) and the world state is updated.

Moreover, some embodiments comprising Hyperledger Fabric may further comprise a consensus mechanism. Hyperledger Fabric's consensus mechanism can be summarized as Crash Fault Tolerant (CFT) and relies on modular components. CFT is a system's ability to continue operating correctly even if one or more of its components fail by “crashing” (i.e., stopping or becoming unresponsive). In essence, a CFT system is designed to withstand node failures without halting or compromising the integrity of its operations. It focuses on recovering from failures where a component simply stops working, rather than dealing with more malicious or Byzantine failures. To that end, endorsement, ordering, validation, and commitment mechanism are deployed. The endorsement mechanism implements a decentralized, policy-driven consensus where only certain peers are responsible for validating transactions. This phase ensures deterministic execution of transactions. The ordering mechanism ensures total ordering of transactions across the network. In one embodiment, Raft is used in production and ensures consensus among ordering nodes (i.e. orderers). Ordering does not validate transactions; it sequences them. The validation and commitment mechanisms achieve final consensus during validation at the peer level. Peers ensure the transaction complies with the endorsement policy and that no conflicts exist in the world state.

In some embodiments where a hash is input, sent to the chaincode, processed (or validated with an external API), and stored, the consensus mechanism ensures the following. The endorsement policies ensure the transaction (e.g. storing the hash and result) must be endorsed by the required peers according to the policy (e.g. “2 out of 3 peers must endorse”). The ordering service guarantees all transactions are sequenced correctly in blocks, even if multiple clients are submitting hashes simultaneously. Subsequently, validation confirms the transaction is valid (e.g., the chaincode was executed correctly, and the hash-to-result mapping is consistent).

As described herein, consensus in Hyperledger Fabric is decentralized, modular, and deterministic, ensuring trust and integrity without energy-intensive mechanisms, such as Proof of Work and Proof of State. The endorsement, ordering, and validation phases collectively achieve consensus. For described use cases, Hyperledger Fabric's consensus ensures reliable, tamper-proof recording of the hash and its processed result.

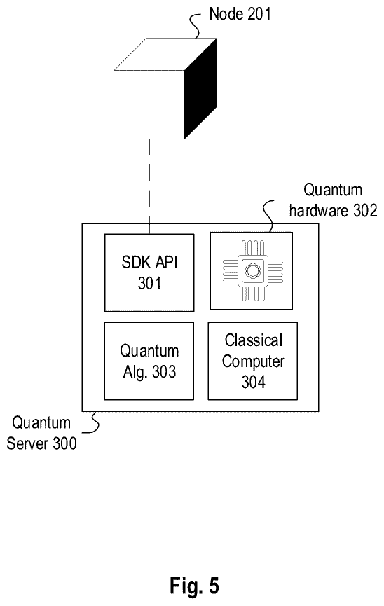

FIG. 5 shows an illustration of one of the plurality of nodes 201 configured to interface with a quantum server 300 comprising a SDK API 301, quantum hardware 302 configured to compute with quantum decryption algorithms 303, and in some embodiments, a classical computer 304. The API 301 may interface with a quantum server 300 through network protocols, such as HTTP/HTTPS, where client requests are transmitted as data packets through physical network infrastructure (e.g., Ethernet cables, fiber optics, or wireless transmitters) to the server's network interface card (NIC). Regarding the integration of classical 304 and quantum hardware 302 within a server architecture, classical computers 304 manage the primary control operations and user interfaces, while being physically connected to quantum processing units (QPUs) through specialized interface hardware such as high-bandwidth, low-latency data buses or dedicated control systems (e.g., arbitrary waveform generators for superconducting qubits). The algorithms operate across this hybrid architecture where classical algorithms run on traditional CPUs/GPUs, while quantum algorithms are translated into quantum circuit instructions by a quantum compiler, which are then transmitted to the QPU's control hardware for execution; the results are subsequently returned to the classical hardware for post-processing and analysis through the same physical interfaces

Quantum hardware 302 comprises a quantum processing unit containing quantum bits implemented through various physical systems such as superconducting circuits, trapped ions, or photonic devices, which are maintained in a highly controlled environment using dilution refrigerators operating at near-absolute zero temperatures or ultra-high vacuum chambers. The hardware includes precision control systems consisting of microwave generators, laser arrays, or voltage controllers that manipulate qubit states, along with specialized readout circuitry and quantum error correction mechanisms to measure and maintain quantum states. Additional critical components include quantum gates for performing quantum operations, coupling devices for enabling multi-qubit interactions, and a complex network of control wiring and filtering systems to isolate the quantum system from environmental noise and decoherence effects while maintaining the delicate quantum properties necessary for computation.

The quantum hardware 302 computes with quantum decryption algorithms 303 including, but not limited to Shor's Algorithm and Grover's Algorithm. Realizing Shor's and Grover's algorithms requires careful quantum hardware considerations. Shor's algorithm, used for factoring, needs a significant number of qubits with long coherence times and high gate fidelity due to its complex circuits. Grover's algorithm, for unstructured searches, also benefits from many qubits, though it can tolerate slightly lower coherence. Quantum SDKs like IBM Qiskit and Google Cirq offer readily available modules for these algorithms, providing a streamlined path for developers seeking these solutions, while still requiring awareness of hardware constraints. These algorithms offer potential breakthroughs in factoring decryption (Shor's) and accelerating unstructured data searches (Grover's). Quantum circuits are highly customizable to optimize performance for specific use cases. For example, in Grover's algorithm, the number of iterations can be adjusted based on the estimated size of the search space to maximize the probability of finding the correct solution. For another example, in Shor's algorithm, the modular exponentiation step can be optimized by choosing different circuit implementations based on the specific number being factored, potentially reducing circuit depth and improving overall accuracy.

Classical computers 303 interface with quantum hardware through a hybrid computing architecture wherein the classical system manages control operations, data preparation, and result interpretation, while the quantum processing unit executes quantum algorithms on quantum bits. The classical computer sends instructions to the quantum hardware through specialized control systems that translate classical binary commands into precise microwave pulses or optical signals that manipulate the quantum states of the qubits, while maintaining the delicate quantum properties such as superposition and entanglement. After quantum operations are performed, the measurement results are converted back into classical information and transmitted to the classical computer for post-processing and analysis, effectively creating a complementary system where the classical computer handles program flow control, error correction, and data management while the quantum hardware performs specialized quantum computations that are intractable for classical systems.

From the above description of Distributed Quantum Evaluation Network, it is manifest that various techniques may be used for implementing the concepts of a distributed quantum decryption method, a computer-implemented distributed quantum decryption method, and a non-transitory computer-readable storage medium comprising computer readable instructions for a distributed quantum decryption, without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that a distributed quantum decryption method, a computer-implemented distributed quantum decryption method, and a non-transitory computer-readable storage medium comprising computer readable instructions for a distributed quantum decryption are not limited to the particular embodiments described herein, but is capable of many embodiments without departing from the scope of the claims.

What is claimed:

1. A distributed quantum decryption method, the steps comprising:
receiving an encrypted string;
initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising:
emitting an event for external computation by calling a quantum computing software development kit (SDK) application programming interface (API),
providing the encrypted string to the quantum computing SDK API, wherein the quantum computing SDK API initiates execution of a quantum circuit configured to perform quantum decryption operation,
receiving a decrypted output generated by the quantum circuit upon completion of the quantum decryption operations,
validating the decrypted output among the plurality of nodes using a distributed consensus protocol, and
storing a validated decrypted output as a new transaction on the DLN; and
updating a distributed ledger state across the plurality of nodes to reflect the storing of the validated decrypted output.

2. The distributed quantum decryption method of claim 1, wherein the encrypted string is received via a graphical user interface.

3. The distributed quantum decryption method of claim 1, wherein the distributed consensus protocol achieves consensus through a mechanism selected from the group consisting of voting, proof-of-work, and proof-of-stake.

4. The distributed quantum decryption method of claim 1, wherein the quantum circuit is designed to implement Shor's Algorithm for integer factoring decryption.

5. The distributed quantum decryption method of claim 1, wherein the quantum circuit is designed to implement Grover's Algorithm for an unstructured search.

6. The distributed quantum decryption method of claim 1, wherein the DLN is the blockchain platform Hyperledger Fabric.

7. A computer-implemented distributed quantum decryption method, the steps comprising:
receiving an encrypted string;
initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising:
emitting an event for external computation by calling a quantum computing software development kit (SDK) application programming interface (API),
providing the encrypted string to the quantum computing SDK API, wherein the quantum computing SDK API initiates execution of a quantum circuit configured to perform quantum decryption operation,
receiving a decrypted output generated by the quantum circuit upon completion of the quantum decryption operations,
validating the decrypted output among the plurality of nodes using a distributed consensus protocol,
storing a validated decrypted output as a new transaction on the DLN; and
updating a distributed ledger state across the plurality of nodes to reflect the storing of the validated decrypted output.

8. The computer-implemented distributed quantum decryption method of claim 7, wherein the encrypted string is received via a graphical user interface.

9. The computer-implemented distributed quantum decryption method of claim 7, wherein the distributed consensus protocol achieves consensus through a mechanism selected from the group consisting of voting, proof-of-work, and proof-of-stake.

10. The computer-implemented distributed quantum decryption method of claim 7, wherein the quantum circuit is designed to implement Shor's Algorithm for integer factoring decryption.

11. The computer-implemented distributed quantum decryption method of claim 7, wherein the quantum circuit is designed to implement Grover's Algorithm for an unstructured search.

12. The computer-implemented distributed quantum decryption method of claim 7, wherein the DLN is the blockchain platform Hyperledger Fabric.

13. A non-transitory computer-readable storage medium comprising computer readable instructions for a distributed quantum decryption method, the instructions performing operations comprising:
receiving an encrypted string;
initiating a chaincode transaction on a plurality of nodes of a disturbed ledger network (DLN), wherein the chaincode transaction further comprises the encrypted string and computer-readable instructions for quantum decryption at each of the plurality of nodes, the instructions comprising:
emitting an event for external computation by calling a quantum computing software development kit (SDK) application programming interface (API),
providing the encrypted string to the quantum computing SDK API, wherein the quantum computing SDK API initiates execution of a quantum circuit configured to perform quantum decryption operation,
receiving a decrypted output generated by the quantum circuit upon completion of the quantum decryption operations,
validating the decrypted output among the plurality of nodes using a distributed consensus protocol,
storing a validated decrypted output as a new transaction on the DLN; and
updating a distributed ledger state across the plurality of nodes to reflect the storing of the validated decrypted output.

14. The non-transitory computer-readable storage medium comprising computer readable instructions for a distributed quantum decryption method of claim 13, wherein the encrypted string is received via a graphical user interface.

15. The non-transitory computer-readable storage medium comprising computer readable instructions for a distributed quantum decryption method of claim 13, wherein the distributed consensus protocol achieves consensus through a mechanism selected from the group consisting of voting, proof-of-work, and proof-of-stake.

16. The non-transitory computer-readable storage medium comprising computer readable instructions for a distributed quantum decryption method of claim 13, wherein the quantum circuit is designed to implement Shor's Algorithm for integer factoring decryption.

17. The non-transitory computer-readable storage medium comprising computer readable instructions for a distributed quantum decryption method of claim 13, wherein the quantum circuit is designed to implement Grover's Algorithm for an unstructured search.

18. The non-transitory computer-readable storage medium comprising computer readable instructions for a distributed quantum decryption method of claim 13, wherein the DLN is the blockchain platform Hyperledger Fabric.

19. The non-transitory computer-readable storage medium comprising computer readable instructions for a distributed quantum decryption method of claim 13, further comprising the step of:
presenting the decrypted output to a graphical user interface or an application programming interface.
